(19) United States
(12) Patent Application Publication
(10) Pub. No.: US 2006/0046882 A1
(43) Pub. Date: Mar. 2, 2006

(54) Tensioning device for a power-transmitting drive

(75) Inventor: Martin Assel, Burgbernheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 11/209,089

(22) Filed: Aug. 22, 2005

(30) Foreign Application Priority Data
Aug. 31, 2004 (DE) 10 2004 041 975.2

(51) Int. Cl. F16H 7/08

(52) U.S. Cl. 474/111

(57) ABSTRACT

A tensioning device for a power-transmitting drive, which can be blocked by a safety element is provided. The safety element (5, 11, 15, 18) can be deactivated automatically through the installation of the tensioning device (1) on a motor or through the installation of another component.

### FIELD OF THE INVENTION

The invention relates to a tensioning device for a power-transmitting drive, which can be blocked by a safety element.

### BACKGROUND OF THE INVENTION

The term “tensioning device” includes both hydraulic and also mechanical take-up devices, which can be formed, for example, as linear take-up devices with a piston or as rotary take-up devices with a pivot arm. Tensioning devices according to the class are usually used as belt or chain tighteners in power-transmitting drives of internal-combustion engines.

In hydraulic tensioning devices for power-transmitting drives, typically a tensioning piston pressed against a chain or a belt is held in a cylinder so that it can move longitudinally. The tensioning piston and the cylinder define a compression chamber for receiving hydraulic fluid, with tightening motions of the tensioning piston in the direction towards the chain creating an enlargement of the compression chamber. Due to the low pressure set in the compression chamber, a non-return valve opens and lets motor oil flow into the compression chamber. When the power-transmitting device is set in tension, the tensioning piston presses inwards, that is, away from the power-transmitting device, with the compression chamber becoming smaller. During this movement of the tensioning piston, motor oil is forced from the compression chamber through a leakage opening.

A tensioning device with a safety element is known from DE 196 80 418 C1. The piston of this tensioning device is inserted into the take-up device housing and held with a safety element, which is formed as a retaining ring. After installation of the tensioning device, the retaining ring is removed, so that the piston can move outwards and contact the power-transmitting device.

From DE 44 28 556 A1, a belt tightener with a device for safe transport is known, which enables simple handling, requires no positioning of the piston, and guarantees safe decoupling.

During or after installation of the tensioning device on the motor, the safety element must be removed manually, whereby the piston is released. If this step is overlooked in the installation of the motor, then the motor is placed in operation without a functional tensioning device. In this case, the generation of undesired noise is to be expected; in an extreme case, the motor can even be damaged due to the forgotten safety element. To prevent someone forgetting to remove the safety element, it has already been proposed to enlarge the safety element, so that the installation of a housing cover or a similar component, with which the power-transmitting drive is covered, is no longer possible. However, despite these safety precautions, there is still the risk that the housing cover will be installed with force and a forgotten safety element will be overlooked.

### SUMMARY

Therefore, the invention is based on the objective of creating a tensioning device with a safety element, whose removal cannot be unintentionally overlooked.

To solve this problem, in a tensioning device of the above noted type, according to the invention the safety element can be deactivated automatically through the installation of the tensioning device on a motor or through the installation of another component.

The invention is particularly well suited for a hydraulic tensioning device with a receiver housing, in which a take-up device housing acting as a cylinder is arranged with a spring-loaded piston held in this cylinder so that it can be displaced and the piston is secured by the safety element. The deactivation or removal of the safety element is realized in the tensioning device according to the invention either through the installation process of the tensioning device on the motor or through the installation of another component, after the tensioning device has already been installed, which is different from tensioning devices with a safety element known in the state of the art. In both cases, the safety element is automatically deactivated, whereby the piston is released and moved under the influence of a spring force. According to the invention, the safety element is formed, such that after its deactivation it is no longer in the way; it remains on or in the tensioning device.

It is especially preferred that the safety element can rotate and/or can be displaced during the installation of a tensioning device on the motor. The attachment can be realized such that the safety element is initially located in a locked position, in which it blocks the movement of the piston. Through the assembly of the tensioning device on the motor or through the assembly of another component, the safety element is rotated and/or displaced, so that it is located in a released position, in which the piston is released and movable.

According to a first embodiment of the invention, the safety element can project past the contact surface of the tensioning device on the motor before the installation of the tensioning device on the motor. In this case, the safety element contacts the motor during the installation, before the tensioning device comes into contact with the motor, whereby the safety element is turned and/or displaced and thus deactivated. The deactivation is performed automatically and compulsorily.

A particularly reliable function can be achieved if the safety element of the tensioning device according to the invention is formed as a safety pin and is guided in a guide of the tensioning device. The guide guarantees that the safety element can be shifted and/or rotated only in a certain direction, thus the deactivation of the safety element is guided in a restricted way accordingly.

In another configuration of the invention, the safety pin can have an angled section. The angled section contacts a surface of the motor, whereby it is rotated or displaced, during the installation of the tensioning device on the motor.

Alternatively, the safety pin can have a U shape in the tensioning device according to the invention. For a U-shaped safety pin, both legs of the safety pin can be guided and moved in parallel, whereby a particularly safe and reliable deactivation and unlocking of the piston is achieved.

According to a second embodiment of the invention, the safety element can be deactivated automatically through the installation of a cover or covering. In this configuration, the deactivation of the safety element and thus the release of the piston occurs only when the tensioning device has already been mounted on the motor. Therefore, it is possible to first mount the hydraulic tensioning device and the corresponding driving wheels or rollers for the various aggregate systems and the power-transmitting device, thus the chain or the belts, and then to deactivate the safety element automatically through the installation of the covering. The deactivation can be performed, so that the inner side of the cover or the covering contacts a part of the safety element, for example, with a free end, and the safety element is therefore displaced or rotated.

In another embodiment of the invention, the cover or covering can have a projecting section, which can contact the safety element during installation. In this way, conventional covers or coverings can be modified in a simple way, so that the safety element is deactivated by this cover during installation without requiring a change to the outer contours of the cover or the covering itself. It is sufficient to attach on the inside a corresponding projecting section or a projection, which contacts and displaces or rotates the safety element during installation.

Preferably, the safety element is made from metal or a plastic material.

### BRIEF DESCRIPTION OF THE DRAWINGS

Additional advantages and details of the invention emerge from the following description of the preferred embodiments with reference to the drawing figures. The figures are schematic representations in which:

FIGS. 1a, 1b show a first embodiment of a tensioning device according to the invention, for which the safety element is deactivated through the installation of the tensioning device on the motor;

FIGS. 2a, 2b show a second embodiment of the invention;

FIG. 3a, 3b show a third embodiment of the invention, for which the safety element is deactivated through the installation of another component; and

FIGS. 4a, 4b show a fourth embodiment of the invention.

### DETAILED DESCRIPTION OF THE PREFERRED EMBODIMENTS

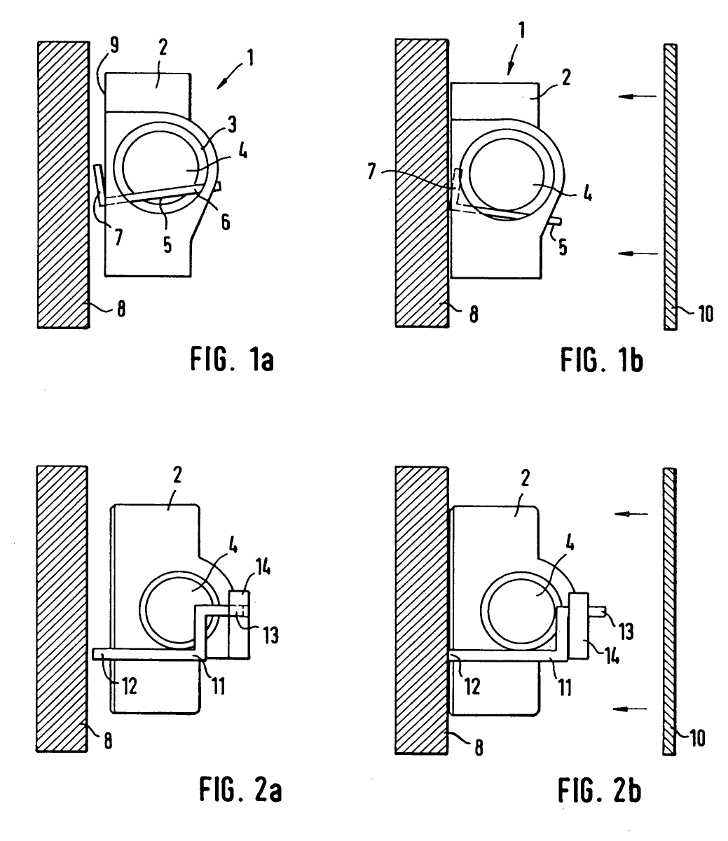

FIGS. 1a and 1b show a tensioning device 1 in a front view, comprising a receiver housing 2, a take-up device housing 3 held therein, and a piston 4 that can be displaced in the take-up device housing 3. The view of FIG. 1a looks axially onto the piston 4, which is completely pushed in and secured by a safety element 5. The safety element 5 comprises a long leg 6 and a short, angled leg 7. The safety element 5 is supported so that it can rotate in the interior of the receiver housing 2 in a guide which is not shown in more detail.

As can be seen in FIG. 1a, the piston 4 is blocked by the long leg 6 of the safety element 5. Thus, the piston 4 cannot leave the take-up device housing 3 or the receiver housing 2. The tensioning device 1 is delivered in this configuration, that is, the configuration with an inserted safety element 5.

The tensioning device 1 is suitable for such uses, in which the power-transmitting device, thus a belt or a chain, has already been installed, when the tensioning device 1 is installed.

Close to the tensioning device 1 on one side, a part of a motor block 8 is shown schematically, on whose surface the tensioning device 1 is installed. The attachment is realized by means of screw connections not shown in FIG. 1a.

The short leg 7 of the safety element 5 projects from the attachment surface 9 of the tensioning device 1, so that the short leg 7 first comes into contact with the motor block 8, when the tensioning device 1 is mounted on the motor. If the tensioning device 1 is set onto the motor block 8, the short leg 7 of the safety element 5 is pressed into the receiver housing 2, in which there is a corresponding open space. In this way, the safety element 5 executes an approximate rotational movement.

The state after the tensioning device 1 is mounted on the motor block 8 is shown in FIG. 1b. The angled short leg 7 of the safety element 5 is located completely within the receiver housing 2, so that the tensioning device 1 can be screwed onto the motor block 8. Through the installation process, the safety element 5 automatically releases the piston 4, so that this piston emerges from the receiver housing 2 assisted by the force of a compression spring. Because the safety element is automatically pushed in and displaced during the installation of the tensioning device 1 on the motor block 8, separate manual actions are not necessary. Then a housing cover 10 can be installed. In this way, the safety element 5 is not in the way.

FIGS. 2a and 2b show a second embodiment of the invention, in which a safety element 11 with two bends is used. Identical components are designated with the same reference numbers as in FIGS. 1a and 1b.

FIG. 2a shows the piston 4 in the locked position. In this position, the angled legs of the safety element 11 prevent the piston 4 from leaving the receiver housing 2. An end section 12 of the safety element 11 projects laterally from the receiver housing 2. The opposite end section 13 is pushed in a guide 14 of the receiver housing 2. The guide 14 is formed as a bore, whose diameter matches the outer diameter of the safety element 11.

During the mounting of the receiver housing 2 on the motor block 8, the safety element 11 is pushed parallel to its long leg, so that the end section 12 no longer projects past the contours of the receiver housing 2. The end section 13 is pushed in the guide 14, so that it projects to the other side of the guide 14 after successful installation.

FIG. 2b shows the tensioning device after installation. The receiver housing 2 contacts flush with the motor block 8. The end section 13 of the safety element 11 projects from the guide 14. The piston is completely released in this position and generates the desired tension in the belt drive. Then the housing cover 10 can be installed.

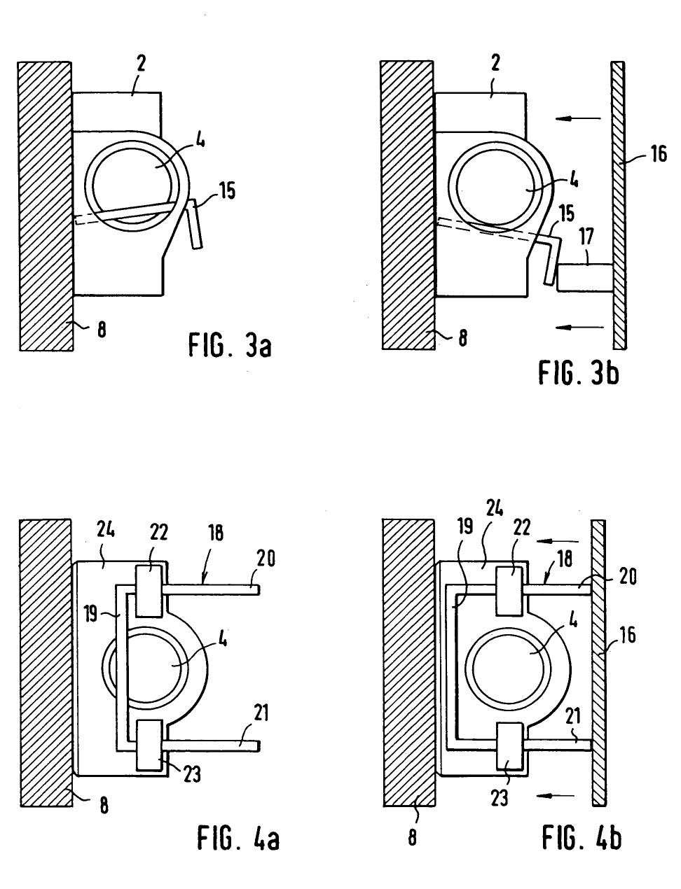

FIGS. 3a and 3b show a third embodiment, for which the safety element is activated through the installation of another component.

FIG. 3a shows the receiver housing 2 of the tensioning device, which has already been mounted on the motor block 8. In the receiver housing 2, a safety element 15 is inserted, which has a long leg and a correspondingly angled short leg. In the position shown in FIG. 3a, the safety element 15 blocks the movement of the piston 4 out of the receiver housing 2. After installation of the receiver housing 2 on the motor block 8, the power-transmitting device, usually a chain or a belt, is installed. The deactivation of the safety element 15, which is used as a device for safe transport, is realized through the installation of another component.

FIG. 3b shows the tensioning device during the installation of a housing cover 16, which has on its inside a projecting section 17. The arrows in FIG. 3b indicate the direction of motion during the installation of the housing cover 16. The projecting section 17 is placed on the inside of the housing cover 16, such that it pushes against the safety element 15 during installation and pivots this safety element away from the piston 4 in the clockwise direction, so that this piston is released after installation of the housing cover 16. The deactivation of the safety element 15 is realized automatically through the installation of the housing cover 16. In contrast, a separate or additional step for removing the device for safe transport is not necessary.

FIGS. 4a and 4b show a fourth embodiment of the invention. The safety element 18 has a U shape, which is different from the previous embodiment. If the device for safe transport, as shown in FIG. 4a, is activated, the middle leg 19 of the safety element 18 is located in front of the piston 4 and blocks this piston. The two parallel legs 20, 21 are guided in guides 22, 23 of the receiver housing 24. Subsequent to the mounting of the receiver housing 24 on the motor block 8, the safety element 18 is deactivated through the installation of a housing cover 16.

FIG. 4b shows the tensioning device after the installation of the housing cover 16. The end sections of the legs 20, 21 are displaced by the housing cover 16 nearly in parallel. Accordingly, the middle leg 19 of the safety element 18 is also moved away from the piston 4, until the piston 4 is completely released. In this position, the piston can emerge from the receiver housing 2 and tension the power-transmitting device. After its deactivation, the safety element 18 used as a device for safe transport remains in the guides 22, 23 of the receiver housing 24 and is not in the way during the operation of the tensioning device.

### REFERENCE NUMBERS

1 Tensioning device
2 Receiver housing
3 Take-up device housing
4 Piston
5 Safety element
6 Leg
7 Leg
8 Motor block
9 Mounting surface
10 Housing cover
11 Safety element
12 End section
13 End section
14 Guide
15 Safety element
16 Housing cover
17 Projecting section
18 Safety element
19 Leg
20 Leg
21 Leg
22 Guide
23 Guide
24 Receiver housing

1. Tensioning device for a power-transmitting drive, which can be blocked by a safety element, comprising a safety element (5, 11, 15, 18) that can be deactivated automatically through installation of the tensioning device (1) on a motor or through installation of another component on the tensioning device or the motor.

2. Tensioning device according to claim 1, wherein the tensioning device is formed as a hydraulic tensioning device (1) and has a receiver housing (2, 24), in which a take-up device housing (3) acting as a cylinder with a spring-loaded piston (4) held displaceably therein is arranged, and the piston (4) is secured by the safety element (5, 11, 15, 18).

3. Tensioning device according to claim 1, wherein the safety element (5, 11, 15, 18) can be rotated and/or displaced by the installation of the tensioning device (1) on the motor.

4. Tensioning device according to claim 1, wherein the safety element (5, 11, 15, 18) projects past a contact surface (9) of the tensioning device (1) before installation.

5. Tensioning device according to claim 1, wherein the safety element (5, 11, 15, 18) comprises a safety pin and is guided in a guide (14, 22, 23) of the tensioning device (1).

6. Tensioning device according to claim 1, wherein the safety element (5, 11, 15, 18) has an angled section.

7. Tensioning device according to claim 1, wherein the safety element (18) has a U shape.

8. Tensioning device according to claim 7, wherein at least one opposing leg (20, 21) of the safety element (18) is guided in a guide (22, 23) of the tensioning device.

9. Tensioning device according to claim 1, wherein the safety element (5, 11, 15, 18) can be deactivated automatically through the installation of a cover (16) or a covering.

10. Tensioning device according to claim 9, wherein the cover (16) or the covering has a projecting section (17), which contacts and deactivates the safety element (18) during installation.

11. Tensioning device according to claim 1, wherein the safety element (5, 11, 15, 18) is made from metal or a plastic material.

12. Tensioning device according to claim 8, wherein both of the opposing legs (20, 21) of the safety element (18) are guided in guides (22, 23) of the tensioning device.
